(19) United States
(12) Patent Application Publication
(10) Pub. No.: US 2026/0122470 A1
(43) Pub. Date: Apr. 30, 2026

(54) SYSTEMS AND METHODS FOR AUTHENTICATION OF DOWNLOADS OF ESIM PROFILES

(71) Applicant: Verizon Patent and Licensing Inc., Basking Ridge, NJ (US)

(72) Inventor: Tarun Verma, Flemington, NJ (US)

(21) Appl. No.: 18/927,343

(22) Filed: Oct. 25, 2024

(51) Int. Cl. H04W 8/18; H04W 12/06; H04W 12/72

(52) U.S. Cl. CPC H04W 8/18; H04W 12/06; H04W 12/72

(57) ABSTRACT

A device may include a processor configured to receive, from a user equipment (UE) device, a request to download an embedded Subscriber Identity Module (eSIM) profile via a blanket code, wherein the blanket code is associated with a pool of available eSIM profiles. The processor may be further configured to determine that a confirmation code is required to download the eSIM profile; provide the confirmation code to an operations support system, in response to determining that the confirmation code is required to download the eSIM profile, wherein the operations support system is to provide the confirmation code to the UE device; receive the confirmation code from the UE device; and provide the requested eSIM profile to the UE device, in response to receiving the confirmation code from the UE device.

### BACKGROUND INFORMATION

To satisfy the needs and demands of users of mobile communication devices, providers of wireless communication services continue to improve and expand available services as well as networks used to deliver such services. One aspect of such improvements includes enabling mobile communication devices to obtain authentication credentials to access a provider network. Managing provision of authentication credentials may pose various difficulties.

### BRIEF DESCRIPTION OF THE DRAWINGS

FIG. 1 illustrates an environment according to an implementation described herein;

FIG. 2 illustrates exemplary components of a device that may be included in an environment according to an implementation described herein;

FIG. 3 illustrates exemplary components of a user equipment (UE) device according to an implementation described herein;

FIG. 4 illustrates exemplary components of a Subscription Management Data Preparation Plus (SM-DP+) system according to an implementation described herein;

FIG. 5 illustrates exemplary components of an embedded Subscriber Identity Module (eSIM) profiles database according to an implementation described herein;

FIG. 6 illustrates a flowchart of a process for obtaining an eSIM profile according to an implementation described herein;

FIG. 7 illustrates a flowchart of a process for authenticating the download of an eSIM profile according to an implementation described herein; and

FIG. 8 illustrates an exemplary signal flow diagram according to an implementation described herein.

### DETAILED DESCRIPTION OF PREFERRED EMBODIMENTS

The following detailed description refers to the accompanying drawings. The same reference numbers in different drawings identify the same or similar elements.

Providers of wireless communication services operate radio access networks (RANs) that include base stations. The base stations enable cellular wireless communication devices (e.g., smart phones, etc.), referred to as user equipment (UE) devices (also herein referred to as UEs), to connect to networks and obtain services via the provider’s core network, such as a Fourth Generation (4G) core network, a Fifth Generation (5G) core network, and/or other next generation networks as defined by the 3^{rd} Generation Partnership Project (3GPP). 5G coverage may be provided using 5G base stations, referred to as gNodeBs, implementing the 5G New Radio (NR) air interface. In order to establish a communication session, a UE device may establish a Protocol Data Unit (PDU) session in the core network, via the RAN. The PDU session may enable the UE device to communicate with another network via the RAN and core networks. The UE device may then establish one or more data flows in the PDU session. Each data flow may be associated with a Quality of Service (QoS) and/or other types of service requirements and may also be referred to as a “QoS data flow” or a “QoS flow.”

In order to register with a core network, a UE device may need to have a valid subscription and be authenticated by the core network. The UE device my include a Subscriber Identity Module (SIM) card, or an embedded SIM (eSIM), that stores information relating to a subscription associated with the UE device. For example, an eSIM card may include a Universal Integrated Circuit Card (UICC) that stores identification, authentication, and/or authorization information for accessing different types of networks. Before a UE device registers with the core network, the UE device may need to download an eSIM profile and store the downloaded eSIM profile to the eSIM. eSIM profiles may be generated, stored, provided, and/or otherwise managed by a Subscription Management Data Preparation Plus (SM-DP+) system.

An enterprise customer, such as, for example, a business, organization, or government agency, may purchase a large number of subscriptions for UE devices for its personnel. The provider of wireless communication services may generate a pool of eSIM profiles for the purchased subscriptions and may enable an efficient mechanism for downloading individual eSIM profiles. One such mechanism is a blanket code that may be used by any UE device associated with the enterprise to download an eSIM profile. The blanket code may include, for example, a Quick Response (QR) code provided to the enterprise and scanned with a camera on a UE device. Scanning the QR code may execute code on the UE device to download an available eSIM profile, from the generated pool of eSIM profiles, from the SM-DP+ system. However, a blanket code may pose a security risk. For example, unauthorized use of the blanket code may deplete the pool of eSIM profiles. Thus, an additional level of authentication may be needed to authorize the download of an eSIM profile using a blanket code.

Implementations described herein relate to systems and methods for authentication of download of eSIM profiles. While the systems and methods are described herein with respect to eSIM profiles, the system and methods may also be implemented with respect to SIM profiles (e.g., with non-embedded SIM cards, etc.). An SM-DP+ system may include a computer device configured to generate a pool of eSIM profiles and configure eSIM profiles in the generated pool to require a confirmation code to be downloaded. For example, the computer device may be configured to generate a blanket code, such as, for example, a blanket Quick Response (QR) code, and set a flag in the generated blanket code to indicate that the confirmation code is required to download the eSIM profile. The blanket code may then be made available to UE devices to download eSIM profiles associated with the generated pool of eSIM profiles.

The computer device may be further configured to receive, from a UE device, a request to download an eSIM profile, from the generated pool of eSIM profiles, via the blanket code, determine that the confirmation code is required to download the eSIM profile, generate the confirmation code, and provide the generated confirmation code to an operations support system, in response to determining that the confirmation code is required to download the eSIM profile. The operations support system may function as an authenticating entity that then provides the confirmation code to the UE device. In some implementations, the computer device may determine that the confirmation code is required to download the eSIM profile based on determining that the received request includes a flag set to indicate that the confirmation code is required to download the eSIM profile. The computer device may be further configured to receive the confirmation code from the UE device and provide the requested eSIM profile to the UE device, in response to receiving the confirmation code from the UE device.

In some implementations, generating the confirmation code may include generating a particular confirmation code for each eSIM profile in the pool of eSIM profiles. In other implementations, generating the confirmation code may include generating the confirmation code for the requested eSIM profile in response to receiving the request to download the eSIM profile via the blanket code. Generating the confirmation code for the requested eSIM profile may include generating a random code, generating a code based on an Integrated Circuit Card Identifier (ICCID) associated with the eSIM profile, generating a code based on an Embedded Identity Document (EID) associated with the UE device, generating a code based on both the ICCID an EID, or generating the code using another technique.

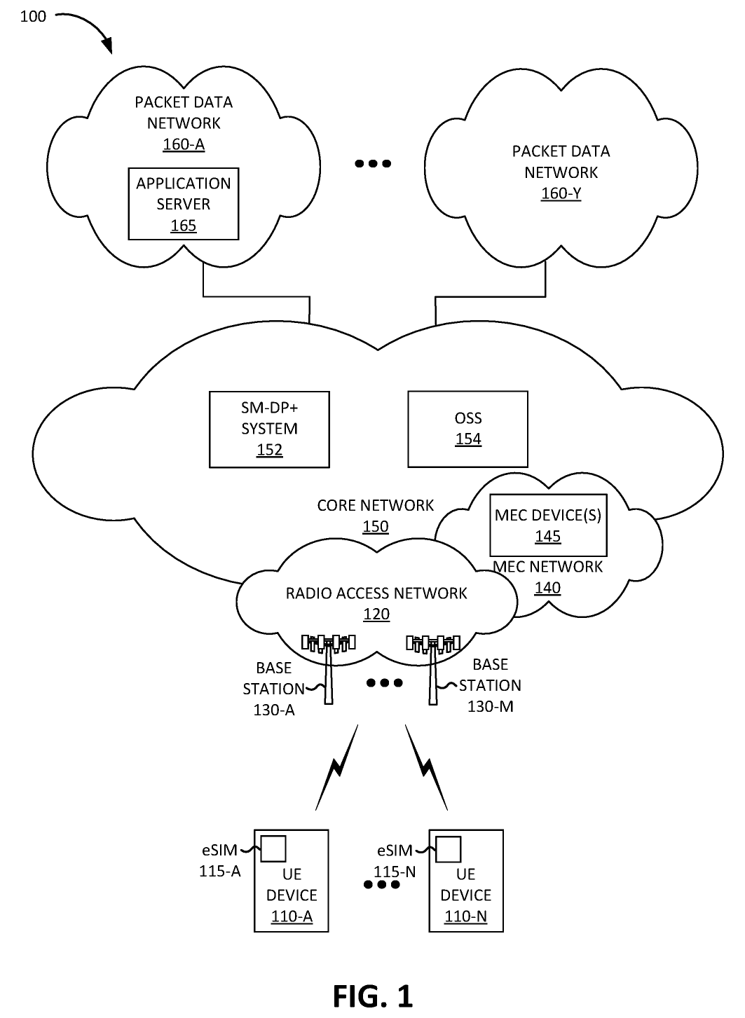

FIG. 1 is a diagram of an exemplary environment 100 in which the systems and/or methods described herein may be implemented. As shown in FIG. 1, environment 100 may include UE devices 110-A to 110-N (referred to herein collectively as “UE devices 110” and individually as “UE device 110”), a RAN 120 that includes base stations 130-A to 130-M (referred to herein collectively as “base stations 130” and individually as “base station 130”), a Multi-Access Edge Computing (MEC) network 140, a core network 150, and packet data networks (PDNs) 160-A to 160-Y (referred to herein collectively as “PDNs 160” and individually as “PDN 160”).

UE device 110 may include any mobile device with cellular wireless communication functionality. UE device 110 may include a handheld wireless communication device (e.g., a mobile phone, a smart phone, a tablet device, etc.); a wearable computer device (e.g., a head-mounted display computer device, a wristwatch computer device, etc.); a laptop computer, a tablet computer, a portable gaming system, and/or another type of portable computer; a Fixed Wireless Access (FWA) device; and/or any other type of mobile computer device with cellular wireless communication capabilities. In some implementations, UE device 110 may communicate using machine-to-machine (M2M) communication, such as Machine Type Communication (MTC), and/or another type of M2M communication for IoT applications.

UE device 110 may include an eSIM 115. eSIM 115 may include an integrated circuit, such as an embedded Universal Integrated Circuit Card (eUICC), which stores subscription information and/or authentication credentials for UE device 110. For example, eSIM 115 may store an eSIM profile that includes an ICCID that uniquely identifies the eSIM profile, a UE device identifier (ID) that identifies a subscription associated with UE device, such as an International Mobile Subscriber Identity (IMSI), and one or more authentication keys for authenticating UE device 110 with RAN 120 and/or core network 150. Furthermore, eSIM 115 may include an EID that uniquely identifies the eSIM. UE device 110 may obtain the eSIM profile for eSIM 115 from SM-DP+ system 152. While FIG. 1 shows a single eSIM 115 in UE device 110 for illustrative purposes, in practice, UE device 110 may include multiple eSIMs 115 (and/or SIMs).

RAN 120 may include base stations 130 and be managed by a provider of wireless communication services. RAN 120 may enable UE devices 110 to connect to core network 150 via base stations 130 using cellular wireless signals. For example, RAN 120 may include one or more central units (CUs), distributed units (DUs), and/or Radio Units (RUs) (not shown in FIG. 1) that enable and manage connections from RUs to core network 150. RAN 120 may include features associated with a Long-Term Evolution (LTE) Advanced (LTE-A) network and/or a 5G network or other next generation network, such as features for, or associated with, management of 5G NR base stations; carrier aggregation; advanced or massive Multiple-Input Multiple Output (MIMO) configurations (e.g., an 8x8 antenna configuration, a 16x16 antenna configuration, a 256x256 antenna configuration, etc.); cooperative MIMO (CO-MIMO); relay stations; Heterogeneous Networks (HetNets) of overlapping small cells and macrocells; Self-Organizing Network (SON) functionality; MTC functionality, such as 1.4 Megahertz (MHz) wide enhanced MTC (eMTC) channels (also referred to as category Cat-M1), Low Power Wide Area (LPWA) technology such as Narrow Band (NB) IoT (NB-IoT) technology, and/or other types of MTC technology; and/or other types of LTE-A and/or 5G functionality.

Base station 130 may include a 5G NR base station (e.g., a gNodeB) and/or a 4G LTE base station (e.g., an eNodeB). Base stations 130 may include devices and/or components configured to enable cellular wireless communication with UE devices 110. For example, base stations 130 may include a radio frequency (RF) transceiver configured to communicate with UE devices 110 using a 5G NR air interface and a 5G NR protocol stack, a 4G LTE air interface and a 4G LTE protocol stack, and/or using another type of cellular air interface.

MEC network 140 may be associated with RAN 120 and may provide MEC services for UE devices 110 attached to base stations 130. MEC network 140 may be in proximity to base stations 130 from a geographic and network topology perspective, thus enabling low latency services to be provided to UE devices 110. As an example, MEC network 140 may be located on the same site as base station 130. As another example, MEC network 140 may be geographically closer to one of base stations 130 and reachable via fewer network hops and/or fewer switches, than other base stations 130.

MEC network 140 may include one or more MEC devices 145. MEC devices 145 may provide MEC services to UE devices 110. A MEC service may include, for example, a low-latency microservice associated with a particular application, a microservice associated with a virtualized network function (VNF) of core network 150, a cloud computing service, such as cache storage service, artificial intelligence (AI) accelerator service, machine learning service, an image processing service, a data compression service, a locally centralized gaming service, a Graphics Processing Units (GPUs) and/or other types of hardware accelerator service, and/or other types of cloud computing services.

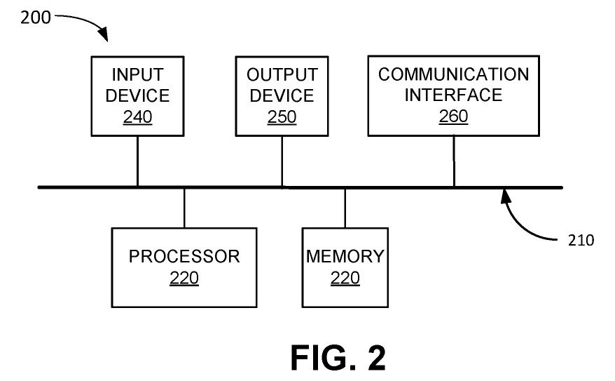

Core network 150 may be managed by the provider of cellular wireless communication services and may manage communication sessions of subscribers connecting to core network 150 via RAN 120. For example, core network 150 may establish an Internet Protocol (IP) connection between UE devices 110 and PDN 160. The components of core network 150 may be implemented as dedicated hardware components and/or as Virtual Network Functions (VNFs) implemented on top of a common shared physical infrastructure using Software Defined Networking (SDN). For example, an SDN controller may implement one or more of the components of core network 150 using an adapter implementing a VNF virtual machine, a Cloud-Native Network Function (CNF) container, an event driven serverless architecture, and/or another type of SDN architecture. The common shared physical infrastructure may be implemented using one or more devices 200 described below with reference to FIG. 2 in a cloud computing center associated with core network 150. Additionally, or alternatively, at least some of the components of core network 150 may be implemented using MEC devices 145 in MEC network 140.

Core network 150 may include an SM-DP+ system 152 and an Operations Support System (OSS) 154. SM-DP+ system 152 may include one or more computer devices, such as an Over-The-Air (OTA) server, that store and manage eSIM profiles and provide an eSIM profile for download to UE device 110 upon request. SM-DP+ system 152 may generate a pool of eSIM profiles and generate a blanket code for downloading eSIM profiles from the pool. SM-DP+ system 152 may provide an eSIM profile to UE device 110 upon receipt of a request. SM-DP+ system 152 may determine that a confirmation code is required to download an eSIM profile from the pool, generate the confirmation code, and provide the confirmation code to OSS 154. If the generated confirmation code is subsequently provided by UE device 110, SM-DP+ system 152 may enable a download of the requested eSIM profile to proceed.

OSS 154 may include one or more computer devices that monitor, control, analyze, and/or otherwise support the operation of RAN 120 and/or core network 150. For example, OSS 154 may provision resources, perform fault management, manage subscriptions, and/or otherwise support operations for RAN 120 and/or core network 150. In particular, OSS 154 may manage delivery of confirmation codes for eSIM profiles. For example, OSS 154 may receive a confirmation code from SM-DP+ system 152 and provide the confirmation code to UE device 110.

PDNs 160-A to 160-Y may each be associated with a Data Network Name (DNN) in 5G, and/or an Access Point Name (APN) in 4G. UE device 110 may request a connection to PDN 160 using a DNN or an APN. For example, UE device 110 may request a data flow connection to an application server 165 (shown in PDN 160-A). UE device 110 may need to register with core network 150 via RAN 120 before being able to connect to core network 150 and communicate with PDN 160. UE device 110 may need to download an eSIM profile before registering with core network 150.

PDN 160 may include, and/or be connected to, a local area network (LAN), a wide area network (WAN), a metropolitan area network (MAN), an autonomous system (AS) on the Internet, an optical network, a cable television network, a satellite network, a wireless network, an ad hoc network, a telephone network (e.g., the Public Switched Telephone Network (PSTN) or a cellular network), an intranet, or a combination of networks. PDN 160 may include application server 165. Application server 165 may include one or more computer devices that host one or more applications and/or other types of services used by UE device 110. Core network 150 may establish a communication session between UE device 110 and application server 165 via RAN 120.

Although FIG. 1 shows exemplary components of environment 100, in other implementations, environment 100 may include fewer components, different components, differently arranged components, or additional components than depicted in FIG. 1. Additionally, or alternatively, one or more components of environment 100 may perform functions described as being performed by one or more other components of environment 100.

FIG. 2 is a diagram illustrating example components of a device 200 according to an implementation described herein. The components of FIG. 1 may each include one or more devices 200. As shown in FIG. 2, device 200 may include a bus 210, a processor 220, a memory 230, an input device 240, an output device 250, and a communication interface 260.

Bus 210 may include a path that permits communication among the components of device 200. Processor 220 may include any type of single-core processor, multi-core processor, microprocessor, latch-based processor, central processing unit (CPU), graphics processing unit (GPU), tensor processing unit (TPU), hardware accelerator, and/or processing logic (or families of processors, microprocessors, and/or processing logics) that interprets and executes instructions. In other embodiments, processor 220 may include an application-specific integrated circuit (ASIC), a field-programmable gate array (FPGA), and/or another type of integrated circuit or processing logic.

Memory 230 may include any type of dynamic storage device that may store information and/or instructions, for execution by processor 220, and/or any type of non-volatile storage device that may store information for use by processor 220. For example, memory 230 may include a random-access memory (RAM) or another type of dynamic storage device, a read-only memory (ROM) device or another type of static storage device, a content addressable memory (CAM), a magnetic and/or optical recording memory device and its corresponding drive (e.g., a hard disk drive, optical drive, etc.), and/or a removable form of memory, such as a flash memory.

Input device 240 may allow an operator to input information into device 200. Input device 240 may include, for example, a keyboard, a mouse, a pen, a microphone, a remote control, an audio capture device, an image and/or video capture device, a touch-screen display, and/or another type of input device. In some implementations, device 200 may be managed remotely and may not include input device 240. In other words, device 200 may be “headless” and may not include a keyboard, for example.

Output device 250 may output information to an operator of device 200. Output device 250 may include a display, a printer, a speaker, and/or another type of output device. For example, device 200 may include a display, which may include a liquid-crystal display (LCD) for displaying content to the user. In some implementations, device 200 may be managed remotely and may not include output device 250. In other words, device 200 may be “headless” and may not include a display, for example.

Communication interface 260 may include a transceiver that enables device 200 to communicate with other devices and/or systems via wireless communications (e.g., radio frequency, infrared, and/or visual optics, etc.), wired communications (e.g., conductive wire, twisted pair cable, coaxial cable, transmission line, fiber optic cable, and/or waveguide, etc.), or a combination of wireless and wired communications. Communication interface 260 may include a transmitter that converts baseband signals to RF signals and/or a receiver that converts RF signals to baseband signals. Communication interface 260 may be coupled to an antenna for transmitting and receiving RF signals.

Communication interface 260 may include a logical component that includes input and/or output ports, input and/or output systems, and/or other input and output components that facilitate the transmission of data to other devices. For example, communication interface 260 may include a network interface card (e.g., Ethernet card) for wired communications and/or a wireless network interface (e.g., a WiFi) card for wireless communications. Communication interface 260 may also include a universal serial bus (USB) port for communications over a cable, a Bluetooth™ wireless interface, a radio-frequency identification (RFID) interface, a near-field communications (NFC) wireless interface, and/or any other type of interface that converts data from one form to another form.

As will be described in detail below, device 200 may perform certain operations relating to downloading an eSIM profile and/or authenticating a download of an eSIM profile. Device 200 may perform these operations in response to processor 220 executing software instructions contained in a computer-readable medium, such as memory 230. A computer-readable medium may be defined as a non-transitory memory device. A memory device may be implemented within a single physical memory device or spread across multiple physical memory devices. The software instructions may be read into memory 230 from another computer-readable medium or from another device. The software instructions contained in memory 230 may cause processor 220 to perform processes described herein. Alternatively, hardwired circuitry may be used in place of, or in combination with, software instructions to implement processes described herein. Thus, implementations described herein are not limited to any specific combination of hardware circuitry and software.

Although FIG. 2 shows exemplary components of device 200, in other implementations, device 200 may include fewer components, different components, additional components, or differently arranged components than depicted in FIG. 2. Additionally, or alternatively, one or more components of device 200 may perform one or more tasks described as being performed by one or more other components of device 200.

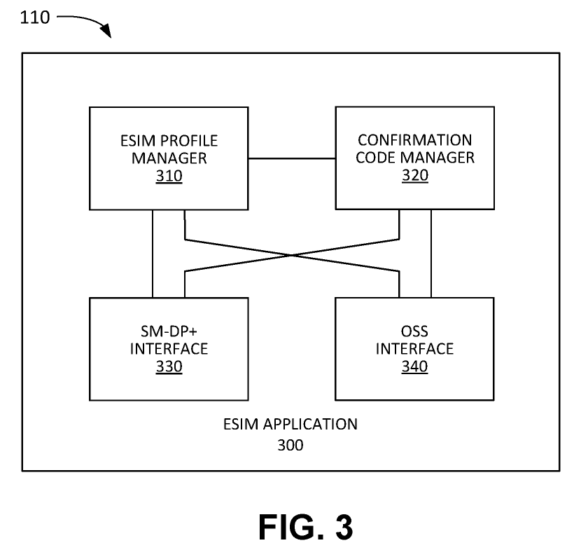

FIG. 3 illustrates exemplary components of UE device 110. The components of UE device 110 may be implemented, for example, via processor 220 executing instructions from memory 230. For example, one or more components of UE device 110 may correspond to the structure of processor 220 together with instructions in memory 230 for implementing the functionality of the component. Alternatively, some or all of the components of UE device 110 may be implemented via hard-wired circuitry. For example, one or more components of UE device 110 may correspond to the structure of some or all of an ASIC, FPGA, and/or another type of integrated circuit. As shown in FIG. 3, UE device 110 may include an eSIM application 300. eSIM application 300 may manage eSIM(s) 115. eSIM application 300 may include an eSIM profile manager 310, a confirmation code manager 320, an SM-DP+ interface 330, and an OSS interface 340.

eSIM profile manager 310 may manage an eSIM profile on eSIM 115. For example, eSIM profile manager 310 may obtain a blanket code and use the blanket code to request to download an eSIM profile from SM-DP+ system 152. For example, eSIM profile manager 310 may access a Uniform Resource Locator (URL) encoded in a QR blanket code and send a request to the URL to download an eSIM profile. The request may include an EID associated with eSIM 115, an IMSI or another UE device ID associated with UE device 110, a pool profile ID associated with a pool of eSIM profiles, a flag indicating that a confirmation code is required to download the eSIM profile, and/or other types of information that may be required to download the eSIM profile. eSIM profile manager 310 may send the request using SM-DP+ interface 330. SM-DP+ interface 330 may be configured to interface with SM-DP+ system 152.

Confirmation code manager 320 may obtain a confirmation code for downloading an eSIM profile. For example, confirmation code manager 320 may obtain a confirmation code from OSS 154 using OSS interface 340. OSS interface 340 may be configured to communicate with OSS 154. Confirmation code manager 320 may then provide the obtained confirmation code to SM-DP+ system 152 using SM-DP+ interface 330. Confirmation code manager 320 may obtain the confirmation code by communicating directly with OSS 154; via an email message, a Short Message Service (SMS) message, an Instant Messaging (IM) message, and/or another type of message; by communicating with another application installed on UE device 110; and/or via manual input by a user of UE device 110. eSIM profile manager 310 may receive the requested eSIM profile from SM-DP+ system 152, after the confirmation code is provided to SM-DP+ system 152, and install the received eSIM profile on eSIM 115.

Although FIG. 3 shows exemplary components of UE device 110, in other implementations, UE device 110 may include fewer components, different components, additional components, or differently arranged components than depicted in FIG. 3. Additionally, or alternatively, one or more components of UE device 110 may perform one or more tasks described as being performed by one or more other components of UE device 110.

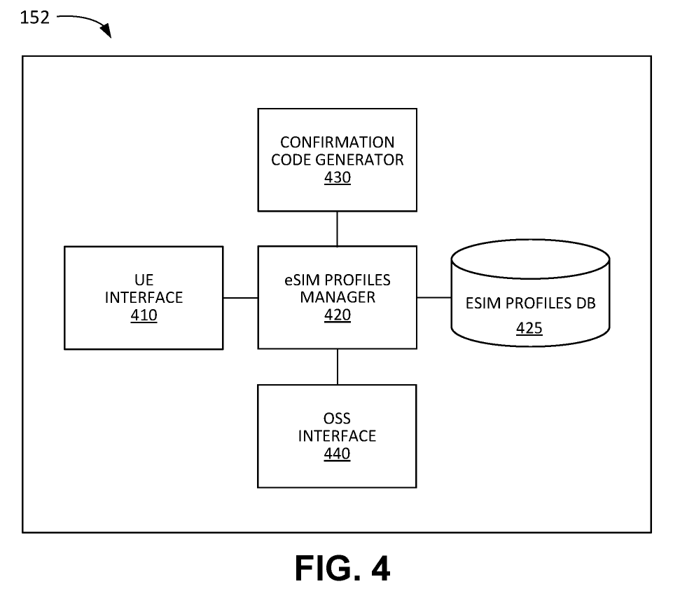

FIG. 4 illustrates exemplary components of SM-DP+ system 152. The components of SM-DP+ system 152 may be implemented, for example, via processor 220 executing instructions from memory 230. For example, one or more components of SM-DP+ system 152 may correspond to the structure of processor 220 together with instructions in memory 230 for implementing the functionality of the component. Alternatively, some or all of the components of SM-DP+ system 152 may be implemented via hard-wired circuitry. For example, one or more components of SM-DP+ system 152 may correspond to the structure of some or all of an ASIC, FPGA, and/or another type of integrated circuit. As shown in FIG. 4, SM-DP+ system 152 may include a UE interface 410, an eSIM profiles manager 420, an eSIM profiles database (DB) 425, a confirmation code generator 430, and an OSS interface 440.

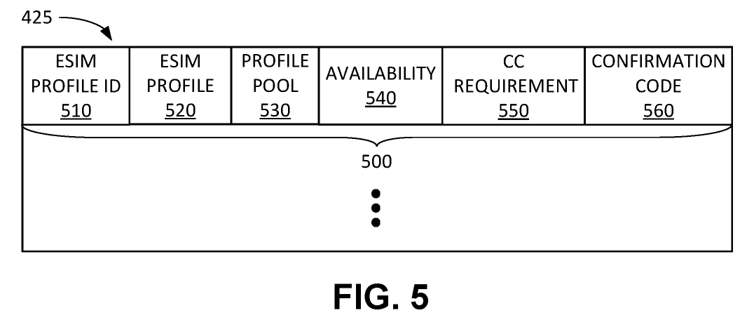

UE interface 410 may be configured to communicate with UE device 110. For example, UE interface 410 may receive a request from UE device 110 to download an eSIM profile and, if a download is authorized, may provide a requested eSIM profile to UE device 110. eSIM profiles manager 420 may manage eSIM profiles stored in eSIM profiles DB 425. eSIM profiles DB 425 may store eSIM profiles managed by SM-DP+ system 152. Exemplary information that may be stored in eSIM profiles DB 425 is described below with reference to FIG. 5.

eSIM profiles manager 420 may generate a pool of eSIM profiles based on instructions received from OSS 154, a provisioning system, an ordering system, and/or an administrator associated with SM-DP+ system 152, and store the generated pool of eSIM profiles in eSIM profiles DB 425. eSIM profiles manager 420 may configure the eSIM profiles in the pool of eSIM profiles to require a confirmation code and generate a blanket code, such as, for example, a blanket QR code, for downloading eSIM profiles from the pool. For example, eSIM profiles manager 420 may indicate in the confirmation code (CC) requirement field 550 of eSIM profile records 500 associated with the pool that a confirmation code is required for download. Additionally, or alternatively, eSIM profiles manager 420 may configure the generated blanket code to set a flag indicating that the confirmation code is required.

eSIM profiles manager 420 may instruct confirmation code generator 430 to generate a confirmation code for an eSIM profile in response to determining that a confirmation code is required to download the eSIM profile. Confirmation code generator 430 may generate a confirmation code for an eSIM profile based on a confirmation code generation rule. The confirmation code may include a particular number of digits and/or alphanumeric characters (e.g., six digits/characters, four digits/characters, eight digits/characters, etc.). In some implementations, confirmation code generator 430 may generate a confirmation code for each eSIM profile in a pool of eSIM profiles when the pool of eSIM profiles is generated and designated as requiring a confirmation code. In other implementation, confirmation code generator 430 may generate a confirmation code for a particular eSIM profile in response to receiving a request to download the eSIM profile.

In some implementations, confirmation code generator 430 may generate a random number as the confirmation code using a random number function, a hardware random number generator, a quantum random number generator, and/or using another technique. In other implementations, confirmation code generator 430 may generate a confirmation code based on an ICCID associated with the eSIM profile, such as, for example, using a set of digits from the ICCID, using a Secure Hash Algorithm 2 (SHA-2) has of the ICCID and using a set of digits from the generated hash, inputting a particular set of digits from the ICCID into a particular mathematical function, and/or using another technique based on the ICCID. In yet other implementations, confirmation code generator 430 may generate a confirmation code based on the EID associated with UE device 110 or based on a combination of the EID and the ICCID (e.g., a combination of particular digits of the ICCID and particular digits of the EID, etc.).

Confirmation code generator 430 may provide the generated code to OSS 154 via OSS interface 440. OSS interface 440 may be configured to communicate with OSS 154. If eSIM profiles manager 420 subsequently receives the generated confirmation code from UE device 110, eSIM profiles manager 420 may provide the eSIM profile to UE device 110, by providing the ICCID and the one or more authentication keys associated with the eSIM profile to UE device 110.

Although FIG. 4 shows exemplary components of SM-DP+ system 152, in other implementations, SM-DP+ system 152 may include fewer components, different components, additional components, or differently arranged components than depicted in FIG. 4. Additionally, or alternatively, one or more components of SM-DP+ system 152 may perform one or more tasks described as being performed by one or more other components of SM-DP+ system 152.

FIG. 5 illustrates exemplary components of eSIM profiles DB 425. As shown in FIG. 5, eSIM profiles DB 425 may include one or more eSIM profile records 500. Each eSIM profile record 500 may include information relating to a particular eSIM profile. eSIM profile record 500 may include an eSIM profile ID field 510, an eSIM profile field 520, a profile pool field 530, an availability field 540, a CC requirement field 550, and a confirmation code field 560.

eSIM profile ID field 510 may store an ID that uniquely identifies an eSIM profile. eSIM profile field 520 may store an ICCID for the eSIM profile and one or more authentication keys for authenticating UE device 110 with RAN 120 and/or core network 150. Profile pool field 530 may store information identifying an eSIM profile pool to which the eSIM profile belongs, such as an eSIM profile pool ID, an enterprise customer ID, and/or another type of ID associated with a pool of eSIM profiles.

Availability field 540 may store information identifying whether the eSIM profile is available to be downloaded or whether the eSIM profile has already been downloaded. If the eSIM profile has been downloaded and is not available, availability field 540 may store information identifying a subscription, UE device ID, and/or EID for UE device 110 that downloaded the eSIM profile. The UE device ID may include, for example, an IMSI, a Mobile Directory Number (MDN), a Mobile Station International Subscriber Directory Number (MSISDN), an International Mobile Equipment Identity (IMEI), and/or another type of UE device ID.

CC requirement field 550 may store information identifying whether a confirmation code is required to download the eSIM profile. Confirmation code field 560 may include a generated confirmation code and/or a rule for generating a confirmation code. For example, a rule may specify that a confirmation code is to be generated as a random code, based on an ICCID associated with the eSIM profile, based on an EID associated with the UE device, based on both the ICCID an EID, and/or using another technique.

Although FIG. 5 shows exemplary components of eSIM profiles DB 425, in other implementations, eSIM profiles DB 425 may include fewer components, different components, additional components, or differently arranged components than depicted in FIG. 5.

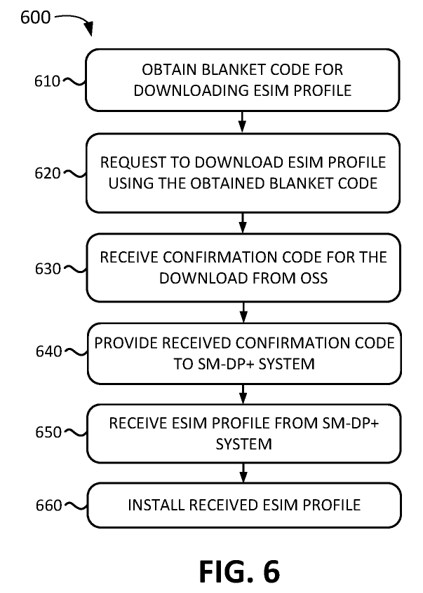

FIG. 6 illustrates a flowchart of a process 600 for obtaining an eSIM profile. In some implementations, process 600 of FIG. 6 may be performed by UE device 110. In other implementations, some or all of process 600 may be performed by another device or a group of devices separate from UE device 110.

As shown in FIG. 6, process 600 may include obtaining a blanket code for downloading an eSIM profile (block 610) and requesting to download an eSIM profile using the obtained blanket code (block 620). For example, UE device 110 may obtain a blanket code and use the blanket code to request to download an eSIM profile from SM-DP+ system 152. For example, the user of UE device 110, when first activating UE device 110, may scan a QR code to download an eSIM profile. In response, UE device 110 may send a request to SM-DP+ system 152 to download an eSIM profile from a pool of eSIM profiles associated with the QR code. The request may include an EID associated with eSIM 115, an IMSI or another UE device ID associated with UE device 110, a pool profile ID associated with a pool of eSIM profiles, a flag indicating that a confirmation code is required to download the eSIM profile, and/or other types of information that may be required to download the eSIM profile.

Process 600 may further include receiving a confirmation code for the download from the OSS (block 630) and providing the received confirmation code to the SM-DP+ system (block 640). In some implementations, UE device 110 may receive the confirmation code via a selected delivery method. For example, when scanning the QR code, the user may be prompted to select a delivery method for receiving the confirmation code, such as, for example, via an email message, SMS, IM, and/or another type of message. In other implementation, UE device 110 may receive the confirmation code via another application, such as a UE device management application associated with the provider that manages core network 150 and/or RAN 120. UE device 110 may receive the confirmation code from OSS 154 and provide the received confirmation code to SM-DP+ system 152.

Process 600 may further include receiving an eSIM profile from the SM-DP+ system (block 650) and installing the received eSIM profile (block 660). For example, UE device 110 may receive the requested eSIM profile from SM-DP+ system 152, after the confirmation code is provided to SM-DP+ system 152, and install the received eSIM profile on eSIM 115.

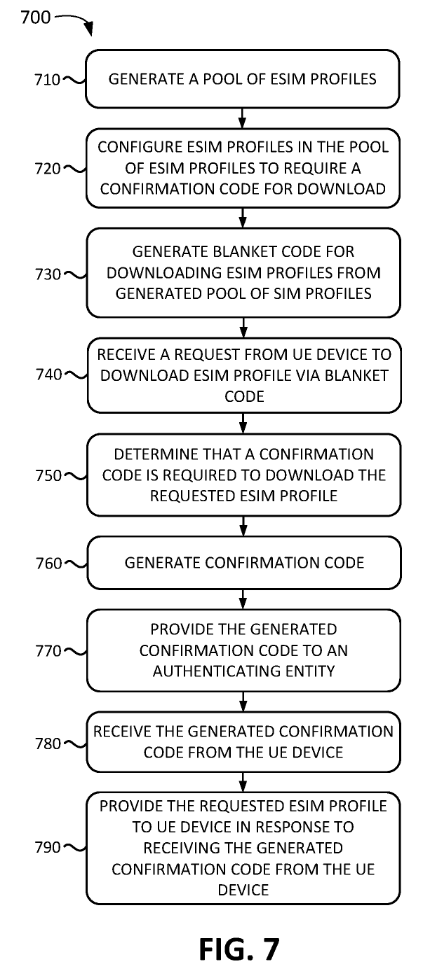

FIG. 7 illustrates a flowchart of a process 700 for authentication the download of an eSIM profile. In some implementations, process 700 of FIG. 7 may be performed by SM-DP+ system 152. In other implementations, some or all of process 700 may be performed by another device or a group of devices separate from SM-DP+ system 152.

As shown in FIG. 7, process 700 may include generating a pool of eSIM profiles (block 710), configuring eSIM profiles in the pool of eSIM profiles to require a confirmation code for download (block 720), and generating a blanket code for downloading eSIM profiles from the generated pool of eSIM profiles (block 730). For example, SM-DP+ system 152 may generate a pool of eSIM profiles based on instructions received from OSS 154, a provisioning system, an ordering system, and/or an administrator associated with SM-DP+ system 152, and store the generated pool of eSIM profiles in eSIM profiles DB 425. SM-DP+ system 152 may configure the eSIM profiles in the pool of eSIM profiles to require a confirmation code and generate a blanket code, such as, for example, a blanket QR code, for downloading eSIM profiles from the pool. For example, SM-DP+ system 152 may indicate in the CC requirement field 550 of eSIM profile records 500 associated with the pool that a confirmation code is required for download, and/or configure the generated blanket code to set a flag indicating that the confirmation code is required.

Process 700 may further include receiving a request from a UE device to download an eSIM profile via the blanket code (block 740), determining that a confirmation code is required to download the requested eSIM profile (block 750), generating the confirmation code (block 760), and providing the generated confirmation code to an authenticating entity (block 770). For example, SM-DP+ system 152 may receive a request from UE device 110 to download an eSIM profile. The received request may include an EID associated with eSIM 115 of UE device 110, an IMSI or another UE device ID associated with UE device 110, a pool profile ID associated with a pool of eSIM profiles, a flag indicating that a confirmation code is required to download the eSIM profile, and/or other types of information that may be required to download the eSIM profile.

SM-DP+ system 152 may generate a confirmation code for an eSIM profile based on a confirmation code generation rule. The confirmation code may include a particular number of digits and/or alphanumeric characters (e.g., six digits/characters, four digits/characters, eight digits/characters, etc.). In some implementations, SM-DP+ system 152 may generate a random number as the confirmation code using a random number function, a hardware random number generator, a quantum random number generator, and/or using another technique. In other implementations, SM-DP+ system 152 may generate a confirmation code based on an ICCID associated with the eSIM profile, such as, for example, using a set of digits from the ICCID, using a SHA-2 has of the ICCID and using a set of digits from the generated hash, inputting a particular set of digits from the ICCID into a particular mathematical function, and/or using another technique based on the ICCID. In yet other implementations, SM-DP+ system 152 may generate a confirmation code based on the EID associated with UE device 110 or based on a combination of the EID and the ICCID (e.g., a combination of particular digits of the ICCID and particular digits of the EID, etc.). SM-DP+ system 152 may provide the generated code to OSS 154 and/or another authenticating entity. The authenticating entity may correspond to a device/system configured to perform authenticating functions for core network 150, RAN 120, and/or UE device 110. In some implementations, the authenticating entity device may correspond to OSS 154. In other implementations, the authenticating entity device may correspond to a different device or system, such as, for example, an authenticating application running on UE device 110.

Process 700 may further include receiving the generated confirmation code from the UE device (block 780) and providing the requested eSIM profile to the UE device in response to receiving the generated confirmation code from the UE device (block 790). For example, SM-DP+ system 152 may receive the generated confirmation code from UE device 110. In response, SM-DP+ system 152 may select an available eSIM profile from the pool of eSIM profiles and provide the selected eSIM profile to UE device 110, by providing the ICCID and the one or more authentication keys associated with the selected eSIM profile to UE device 110. Furthermore, SM-DP+ system 152 may provide information relating to the selected eSIM profile to a subscription management system associated with core network 150, such as to a Unified Data Repository (UDR) in core network 150.

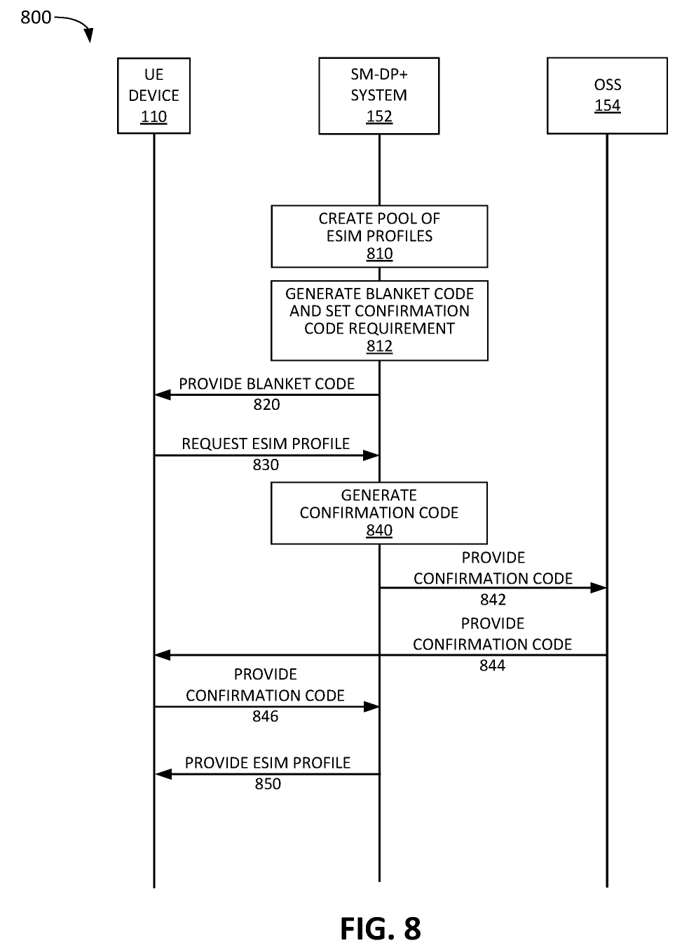

FIG. 8 illustrates an exemplary signal flow diagram 800 according to an implementation described herein. As shown in FIG. 8, signal flow diagram 800 may include SM-DP+ system 152 creating a pool of eSIM profiles (block 810) and generating a blanket code and setting a confirmation code requirement (block 820). For example, SM-DP+ system 152 may generate a pool of eSIM profiles and configure the eSIM profiles in the generated pool of eSIM profiles to require a confirmation code, based on instructions received from OSS 154 (not shown in FIG. 8), a provisioning system, an ordering system, and/or an administrator associated with SM-DP+ system 152. SM-DP+ system 152 may generate a blanket QR code, set a flag in the generated blanket QR code indicating that a confirmation code is required to download eSIM profiles from the pool, and provide the generated blanket code to UE device 110 (signal 820). As an example, SM-DP+ system 152 may send a message to UE device 110 with the generated blanket QR code. As another example, UE device 110 may access an URL associated with SM-DP+ system 152 to obtain the generated blanket QR code.

Signal flow diagram 800 may further include UE device 110 requesting to download an eSIM profile from SM-DP+ system 152 (signal 830). For example, when the user of UE device 110 selects to activate UE device 110 and register UE device 110 with core network 150, the user may use UE device 110 to scan the received blanket QR code. SM-DP+ system 152 may determine, based on the flag set in blanket QR code, that a confirmation code is required, and, in response, generate the confirmation code (block 840) and provide the confirmation code to OSS 154 along with information identifying UE device 110 (signal 842). OSS 154 may then provide the confirmation code to UE device 110 (signal 844). UE device 110 may then provide the received confirmation code to SM-DP+ system 152 (signal 846). SM-DP+ system 152 may authenticate the confirmation code and, in response, select an eSIM profile from the pool of eSIM profiles associated with the blanket QR code, and provide the selected eSIM profile to UE device 110 (signal 850). UE device 110 may install the received eSIM profile on eSIM 115 and proceed to register with core network 150 via RAN 120.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

For example, while a series of blocks have been described with respect to FIGS. 6 and 7, and a series of signals have been described with respect to FIG. 8, the order of the blocks, and/or signals, may be modified in other implementations. Further, non-dependent blocks and/or signals may be performed in parallel.

It will be apparent that systems and/or methods, as described above, may be implemented in many different forms of software, firmware, and hardware in the implementations illustrated in the figures. The actual software code or specialized control hardware used to implement these systems and methods is not limiting of the embodiments. Thus, the operation and behavior of the systems and methods were described without reference to the specific software code--it being understood that software and control hardware can be designed to implement the systems and methods based on the description herein.

Further, certain portions, described above, may be implemented as a component that performs one or more functions. A component, as used herein, may include hardware, such as a processor, an ASIC, or a FPGA, or a combination of hardware and software (e.g., a processor executing software).

It should be emphasized that the terms “comprises” / “comprising” when used in this specification are taken to specify the presence of stated features, integers, steps or components but does not preclude the presence or addition of one or more other features, integers, steps, components or groups thereof.

The term “logic,” as used herein, may refer to a combination of one or more processors configured to execute instructions stored in one or more memory devices, may refer to hardwired circuitry, and/or may refer to a combination thereof. Furthermore, a logic may be included in a single device or may be distributed across multiple, and possibly remote, devices.

For the purposes of describing and defining the present invention, it is additionally noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

To the extent the aforementioned embodiments collect, store, or employ personal information of individuals, it should be understood that such information shall be collected, stored, and used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, act, or instruction used in the present application should be construed as critical or essential to the embodiments unless explicitly described as such. Also, as used herein, the article "a" is intended to include one or more items. Further, the phrase "based on" is intended to mean "based, at least in part, on" unless explicitly stated otherwise.

What is claimed is:

1. A method comprising:
receiving, by a device and from a user equipment (UE) device, a request to download an embedded Subscriber Identity Module (eSIM) profile via a blanket code, wherein the blanket code is associated with a pool of available eSIM profiles;
determining, by the device, that a confirmation code is required to download the eSIM profile;
providing, by the device, the confirmation code to an operations support system, in response to determining that the confirmation code is required to download the eSIM profile, wherein the operations support system is to provide the confirmation code to the UE device;
receiving, by the device, the confirmation code from the UE device; and
providing, by the device, the requested eSIM profile to the UE device, in response to receiving the confirmation code from the UE device.

2. The method of claim 1, further comprising:
generating the pool of eSIM profiles; and
configuring particular eSIM profiles of the pool of eSIM profiles to require a confirmation code to be downloaded.

3. The method of claim 2, wherein configuring particular eSIM profiles of the pool of eSIM profiles to require a confirmation code to be downloaded includes:
generating the blanket code, wherein the blanket code includes a flag set to indicate that the confirmation code is required to download the eSIM profile.

4. The method of claim 3, wherein the blanket code includes a Quick Response (QR) code.

5. The method of claim 1, further comprising:
generating a particular confirmation code for each eSIM profile in the pool of eSIM profiles.

6. The method of claim 1, further comprising:
generating the confirmation code for the requested eSIM profile, in response to receiving the request to download the eSIM profile via the blanket code and determining that the confirmation code is required to download the eSIM profile.

7. The method of claim 6, wherein generating the confirmation code for the requested eSIM profile includes:
generating a random code;
generating a code based on an Integrated Circuit Card Identifier (ICCID) associated with the eSIM profile; or
generating a code based on an Embedded Identity Document (EID) associated with the UE device.

8. The method of claim 1, wherein determining that the confirmation code is required to download the eSIM profile includes:
determining that the blanket code includes a flag set to indicate that the confirmation code is required to download the eSIM profile.

9. A device comprising:
a processor configured to:
receive, from a user equipment (UE) device, a request to download an embedded Subscriber Identity Module (eSIM) profile via a blanket code, wherein the blanket code is associated with a pool of available eSIM profiles;
determine that a confirmation code is required to download the eSIM profile;
provide the confirmation code to an operations support system, in response to determining that the confirmation code is required to download the eSIM profile, wherein the operations support system is to provide the confirmation code to the UE device;
receive the confirmation code from the UE device; and
provide the requested eSIM profile to the UE device, in response to receiving the confirmation code from the UE device.

10. The device of claim 9, wherein the processor is further configured to:
generate the pool of eSIM profiles; and
configure particular eSIM profiles of the pool of eSIM profiles to require a confirmation code to be downloaded.

11. The device of claim 10, wherein, when configuring particular eSIM profiles of the pool of eSIM profiles to require a confirmation code to be downloaded, the processor is further configured to:
generate the blanket code, wherein the blanket code includes a flag set to indicate that the confirmation code is required to download the eSIM profile.

12. The device of claim 11, wherein the blanket code includes a Quick Response (QR) code.

13. The device of claim 9, wherein the processor is further configured to:
generate a particular confirmation code for each eSIM profile in the pool of eSIM profiles.

14. The device of claim 9, wherein the processor is further configured to:
generate the confirmation code for the requested eSIM profile, in response to receiving the request to download the eSIM profile via the blanket code and determining that the confirmation code is required to download the eSIM profile.

15. The device of claim 14, wherein, when generating the confirmation code for the requested eSIM profile, the processor is configured to:
generate a random code;
generate a code based on an Integrated Circuit Card Identifier (ICCID) associated with the eSIM profile; or
generate a code based on an Embedded Identity Document (EID) associated with the UE device.

16. The device of claim 9, wherein, when determining that the confirmation code is required to download the eSIM profile, the processor is configured to:
determine that the blanket code includes a flag set to indicate that the confirmation code is required to download the eSIM profile.

17. A non-transitory computer-readable memory device storing instructions executable by a processor, the non-transitory computer-readable memory device comprising:
one or more instructions to receive, from a user equipment (UE) device, a request to download an embedded Subscriber Identity Module (eSIM) profile via a blanket code, wherein the blanket code is associated with a pool of available eSIM profiles;
one or more instructions to determine that a confirmation code is required to download the eSIM profile;
one or more instructions to provide the confirmation code to an operations support system, in response to determining that the confirmation code is required to download the eSIM profile, wherein the operations support system is to provide the confirmation code to the UE device;
one or more instructions to receive the confirmation code from the UE device; and
one or more instructions to provide the requested eSIM profile to the UE device, in response to receiving the confirmation code from the UE device.

18. The non-transitory computer-readable memory device of claim 17, further comprising:
one or more instructions to generate the pool of eSIM profiles; and
one or more instructions to configure particular eSIM profiles of the pool of eSIM profiles to require a confirmation code to be downloaded.

19. The non-transitory computer-readable memory device of claim 17, further comprising:
one or more instructions to generate the confirmation code for the requested eSIM profile, in response to receiving the request to download the eSIM profile via the blanket code and determining that the confirmation code is required to download the eSIM profile.

20. The non-transitory computer-readable memory device of claim 17, wherein the one or more instructions to determine that the confirmation code is required to download the eSIM profile include:
one or more instructions to determine that the blanket code includes a flag set to indicate that the confirmation code is required to download the eSIM profile.
